(19) United States
(12) Patent Application Publication
(10) Pub. No.: US 2025/0388797 A1
(43) Pub. Date: Dec. 25, 2025

(54) HIGH THERMAL STORAGE DENSITY AND PREPARATION METHOD THEREOF

(71) Applicant: ANHUI UNIVERSITY OF TECHNOLOGY, Ma'anshan City (CN)

(72) Inventors: Haiyun YU, Ma'anshan City (CN); Hao HU, Ma'anshan City (CN); Beihang XI, Ma'anshan City (CN); Haohan ZHANG, Ma'anshan City (CN); Cuihong ZHENG, Ma'anshan City (CN); Saisai LI, Ma'anshan City (CN); Xu YANG, Ma'anshan City (CN)

(73) Assignee: ANHUI UNIVERSITY OF TECHNOLOGY, Ma'anshan City (CN)

(21) Appl. No.: 19/063,715

(22) Filed: Feb. 26, 2025

Related U.S. Application Data
(63) Continuation of application No. PCT/CN2025/071944, filed on Jan. 13, 2025.

(30) Foreign Application Priority Data
Jun. 20, 2024 (CN) 202410802051.X

(51) Int. Cl. C09K 5/06; B01F 33/45; F28D 20/02

(52) U.S. Cl. CPC C09K 5/063; B01F 33/45; F28D 20/02

(57) ABSTRACT

A composite phase change material with a high thermal storage density and a preparation method are provided. The preparation method includes the following steps: oxalic acid dihydrate, glutaric acid, magnesium sulfate heptahydrate and alkylolamide phosphate are mixed uniformly according to parts of mass, then heated and held for a period of time, further stirred at a constant temperature, and then cooled to room temperature for solidification, and finally a composite phase change material with a high thermal storage density is obtained.

### CROSS-REFERENCE TO RELATED APPLICATIONS

This application is a continuation of PCT/CN2025/071944, filed Jan. 13, 2025, which claims priority of Chinese Patent Application No. 202410802051.X, filed Jun. 20, 2024, the entire contents of which are incorporated herein by reference.

### TECHNICAL FIELD

The present disclosure relates to ambient temperature control materials, and specifically to a composite phase change material with a high thermal storage density and a preparation method thereof.

### BACKGROUND

Some precision electronic components (e.g. 5G equipment, radar, etc.) generate a large amount of heat during operation, causing the ambient temperature to rise above the working temperature required by the working system, leading to a decrease in the efficacy and lifespan of the equipment, or even damage. To address this problem, the current main method is to use phase change materials with suitable phase change temperatures to be laminated or wrapped around the electronic components, so that the surrounding ambient temperature may be controlled within the operating temperature range of the device through the absorption of heat by the phase change materials to realize ambient temperature management. Phase change energy storage material, a good material for controlling ambient temperature, has characteristics of little change in temperature when absorbing heat, and thus may be used to absorb heat released by the system and keep the ambient temperature relatively stable for a certain period of time, so as to achieve the purpose of regulating and controlling the ambient temperature. Phase change materials used for temperature control of electronic components usually need a phase change temperature of 65° C. to 75° C., and need as much latent heat of phase change as possible. At present, the material commonly used for thermal management of ambient temperature is high-purity paraffin with a carbon chain length greater than 32 and a latent heat value of fusion 200-240 J/g, but it has shortcomings of flammability and high cost. In addition, most of the phase change materials on the market today cannot meet the needs of ambient temperature control.

Compared with high-purity paraffin, oxalic acid dihydrate has higher latent heat of phase change (364 J/g) and is more cheap and easy to obtain, but also has the disadvantages of higher phase change temperature (99° C.) and stronger corrosiveness when applied to ambient temperature control, so the oxalic acid dihydrate cannot be directly used in the ambient temperature control of electronic components. At present, there are relatively few studies on oxalic acid dihydrate-based composites at home and abroad: scholars from South China University of Technology obtained a composite phase change material with a phase change temperature of 56.13° C. and a latent heat of phase change of 246.9 J/g by compositing oxalic acid dihydrate and aluminum ammonium sulfate dodecahydrate (Kai Wang, Preparation and properties of oxalic aciddihydrate-ammonium alum eutectic/zirconia modified expanded graphite composite phase change material, South China University of Technology, Master's thesis, 2021); scholars from Qinghai institute of Salt Lakes, Chinese Academy of Sciences obtained a composite phase change material with a phase change temperature of 88.7° C. and a latent heat of phase change of 328.2 J/g by compositing oxalic acid dihydrate and sodium chloride (Lipeng Han, Investigation of the Durability of Oxalic Acid Dihydrate Phase Change Material, Master's thesis, Qinghai institute of Salt Lakes, Chinese Academy of Sciences, 2019). There are also reports that a phase change material with a phase change temperature of 87.3° C. and a latent heat of phase change of 344 J/g was obtained by compositing oxalic acid dihydrate and borax (Solar Energy Materials and Solar Cells, 2017, (168):38-44). Although the above studies reduced the phase change temperature by compositing oxalic acid dihydrate and soluble inorganic salts to form a eutectic or eutectic mixture, none of the melting temperatures is not within the range of ambient temperatures commonly used in electronic components, and the addition of the inorganic salts increased the ionic conductivity of the phase change materials during melting, which led to a further increase in electrochemical corrosion of metals.

### SUMMARY

An objective of the present disclosure is to provide a composite phase change material with a high thermal storage density and a preparation method thereof, and the obtained composite phase change material is more suitable for the temperature control of electronic components, so as to overcome the shortcomings of the current phase change materials in the field of ambient temperature control, such as flammable and high-cost high purity paraffin and highly corrosive oxalic acid dihydrate phase change materials whose melting point does not meet the requirements of environmental temperature control.

In order to achieve the above objective, the disclosure provides a composite phase change material with a high thermal storage density, including oxalic acid dihydrate, organic acid, magnesium sulfate heptahydrate and alkylolamide phosphate ester, where the composite phase change material is prepared according to the following proportions, steps, and reaction conditions:
S1: under stirring conditions, mixing oxalic acid dihydrate, organic acid, magnesium sulfate heptahydrate and alkylolamide phosphate ester uniformly in parts by mass to obtain a mixture A;
S2: sealing and keeping the mixture obtained in S1 at a certain temperature for a certain time and then magnetically stirring the mixture A at a constant temperature for a certain time to obtain a mixture B; and
S3: naturally cooling the mixture B obtained in S2 to room temperature for solidification to obtain the composite phase change material.

Further, in the composite phase change material with a high thermal storage density, the oxalic acid dihydrate, the organic acid, the magnesium sulfate heptahydrate and the alkylolamide phosphate ester in S1 are in a ratio of 40:60:1:0.05-0.4 in parts by mass.

Further, in the composite phase change material with a high thermal storage density, the oxalic acid dihydrate, the organic acid, the magnesium sulfate heptahydrate and the alkylolamide phosphate ester in S1 are in a ratio of 40:60:1:0.1 in parts by mass.

Further, in the composite phase change material with a high thermal storage density, the organic acid in the S1 is glutaric acid.

Further, in the composite phase change material with a high thermal storage density, the sealing in S2 is carried out at 95-105° C. for 2.5-3.5 h, and the magnetic stirring is carried out at 100° C. for 20-30 min.

Further, in the composite phase change material with a high thermal storage density, the sealing in S2 is carried out at 100° C.

Further, in the composite phase change material with a high thermal storage density, the sealing in S2 is carried out at 100° C. for 3 h.

Further, in the composite phase change material with a high thermal storage density, the magnetic stirring in S2 is carried out for 25 min.

Compared with prior art, the disclosure has the following effects.

Compared to high-purity paraffin waxes with melting points in the 65° C.-75° C., the material obtained in the present disclosure have a significantly higher thermal storage density than paraffin waxes, are not capable of spontaneous combustion (paraffin waxes are combustible), and are cheaper to produce. In contrast to other publicly available dihydrate oxalic acid composite phase change materials, the present disclosure does not use an inorganic salt for compounding, but instead adjust the melting point of the dihydrate oxalic acid through organic acids, inhibits hydrolysis through the organic acids when the dihydrate oxalic acid melts, and, further reduces the corrosive effect of the material to metal in conjunction with an alkylolamide phosphate ester. Moreover, the composite phase change material with a high thermal storage density obtained in the present disclosure are characterized by good thermal cycling stability.

### BRIEF DESCRIPTION OF THE DRAWINGS

FIG. 1 shows a differential scanning calorimetry (DSC) diagram of Embodiment 1.

FIG. 2 shows a DSC diagram of Embodiment 2.

FIG. 3 shows a DSC diagram of Embodiment 3.

FIG. 4 shows a DSC diagram of Embodiment 4.

FIG. 5 shows a DSC diagram of Embodiment 5.

FIG. 6 shows tafel curves of Embodiment 1 and Comparative example 1.

FIG. 7 shows a flow chart of a preparation method of a composite phase change material with a high thermal storage density.

### DETAILED DESCRIPTION OF THE EMBODIMENTS

To better illustrate the products involved in this disclosure, specific embodiments are as follows.

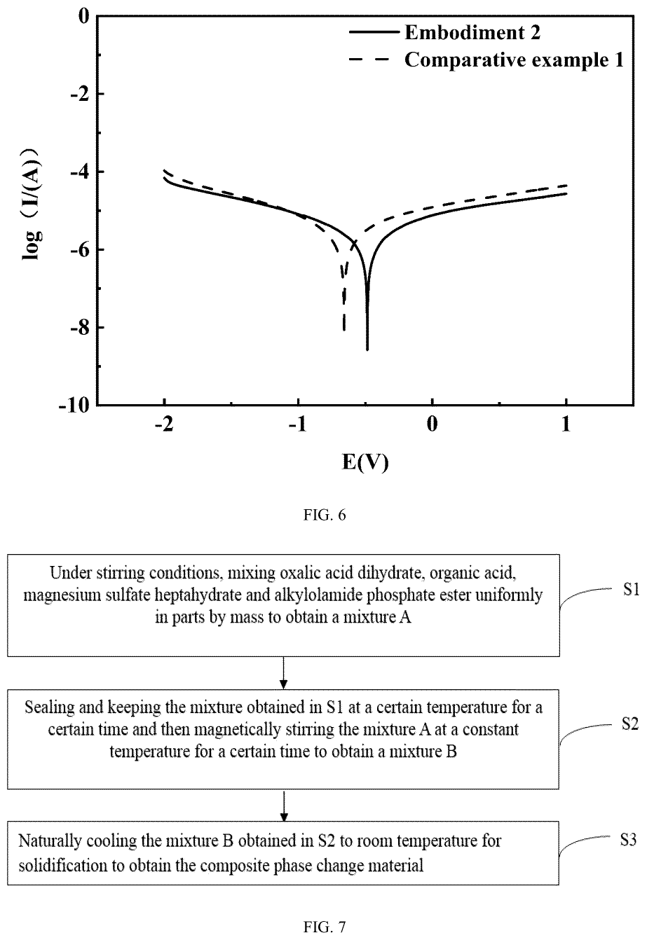

A preparation method of a composite phase change material with a high thermal storage density is shown in FIG. 7

### Embodiment 1

Oxalic acid dihydrate, glutaric acid, magnesium sulfate heptahydrate and alkylolamide phosphate are uniformly mixed in accordance with the mass ratio of 40:60:1:0.05, then sealed at 105° C. for 2.5 h, further magnetically stirred at a constant temperature of 100° C. for 20 min, and then naturally cooled to room temperature for solidification, so that a composite phase change material with a high thermal storage density is obtained.

### Embodiment 2

Oxalic acid dihydrate, glutaric acid, magnesium sulfate heptahydrate and alkylolamide phosphate are uniformly mixed in accordance with the mass ratio of 40:60:1:0.1, then sealed at 100° C. for 3 h, further magnetically stirred at a constant temperature of 100° C. for 25 min, and then naturally cooled to room temperature for solidification, so that a composite phase change material with a high thermal storage density is obtained.

### Embodiment 3

Oxalic acid dihydrate, glutaric acid, magnesium sulfate heptahydrate and alkylolamide phosphate are uniformly mixed in accordance with the mass ratio of 40:60:1:0.2, then sealed at 100° C. for 3 h, further magnetically stirred at a constant temperature of 100° C. for 25 min, and then naturally cooled to room temperature for solidification, so that a composite phase change material with a high thermal storage density is obtained.

### Embodiment 4

Oxalic acid dihydrate, glutaric acid, magnesium sulfate heptahydrate and alkylolamide phosphate are uniformly mixed in accordance with the mass ratio of 40:60:1:0.3, then sealed at 100° C. for 3 h, further magnetically stirred at a constant temperature of 100° C. for 25 min, and then naturally cooled to room temperature for solidification, so that a composite phase change material with a high thermal storage density is obtained.

### Embodiment 5

Oxalic acid dihydrate, glutaric acid, magnesium sulfate heptahydrate and alkylolamide phosphate are uniformly mixed in accordance with the mass ratio of 40:60:1:0.4, then sealed at 95° C. for 3.5 h, further magnetically stirred at a constant temperature of 100° C. for 30 min, and then naturally cooled to room temperature for solidification, so that a composite phase change material with a high thermal storage density is obtained.

### Comparative Example 1

Oxalic acid dihydrate, glutaric acid and magnesium sulfate heptahydrate are uniformly mixed in accordance with the mass ratio of 40:60:1, then sealed at 100° C. for 3 h, further magnetically stirred at a constant temperature of 100° C. for 25 min, and then naturally cooled to room temperature for solidification, so that a composite phase change material with a high thermal storage density is obtained.

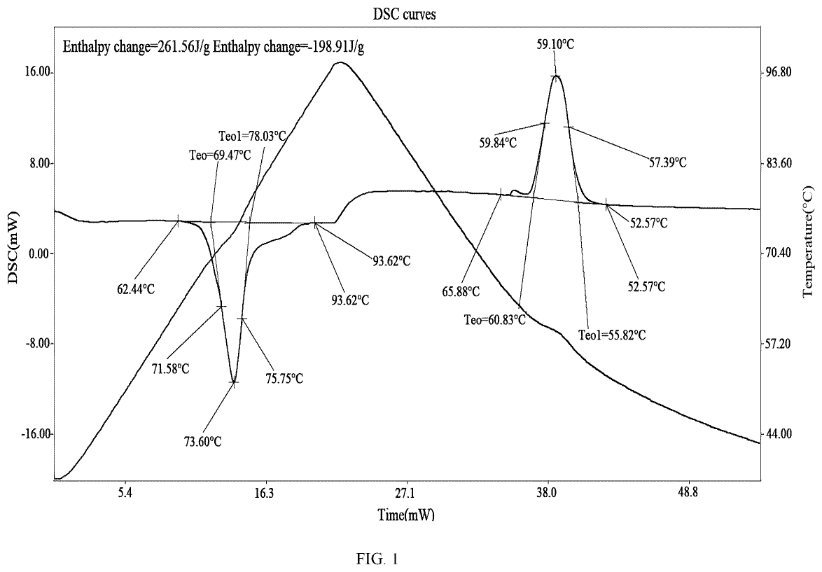

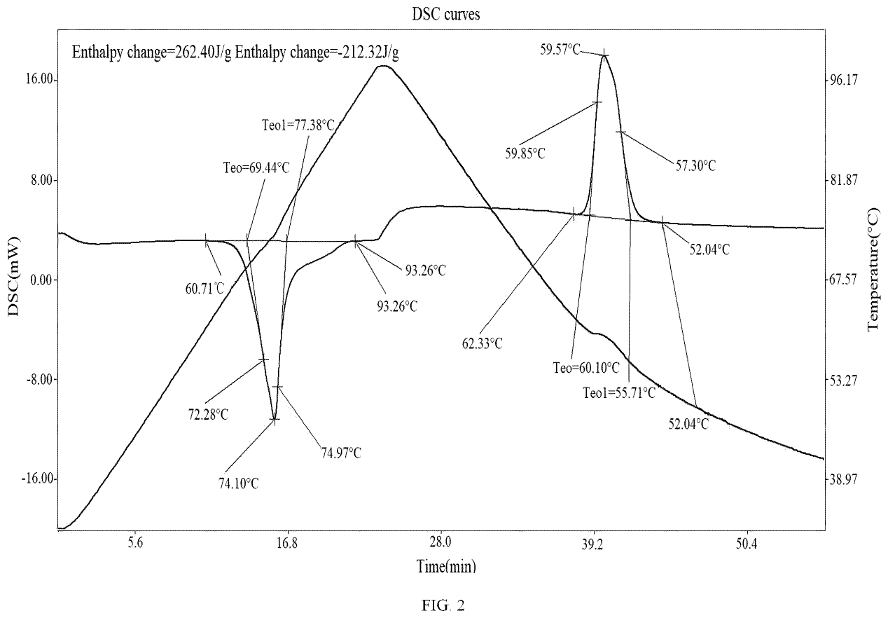

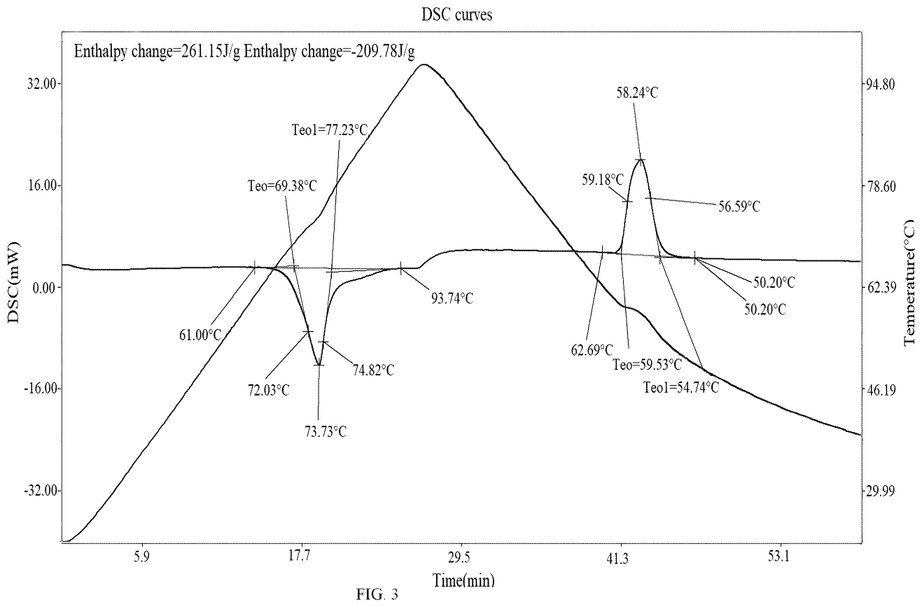

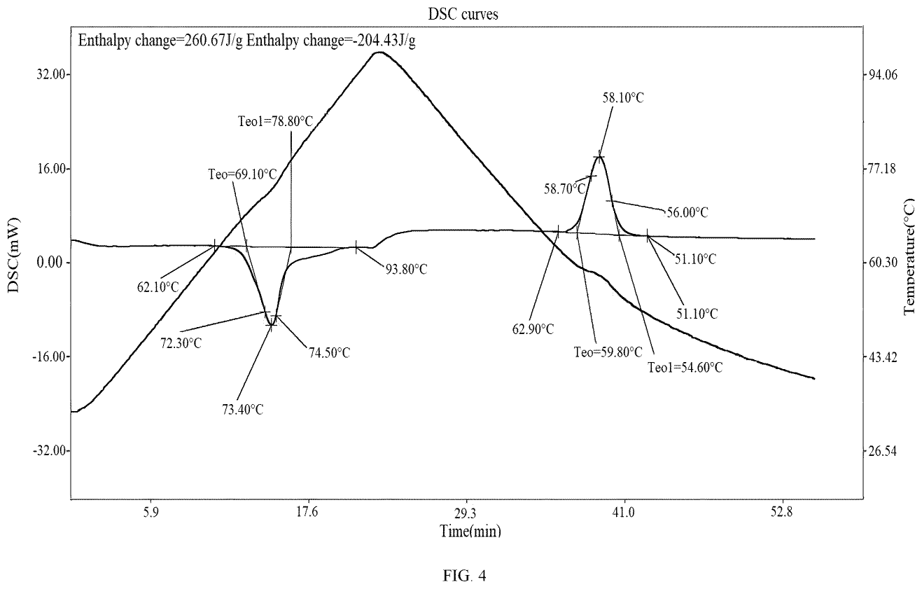

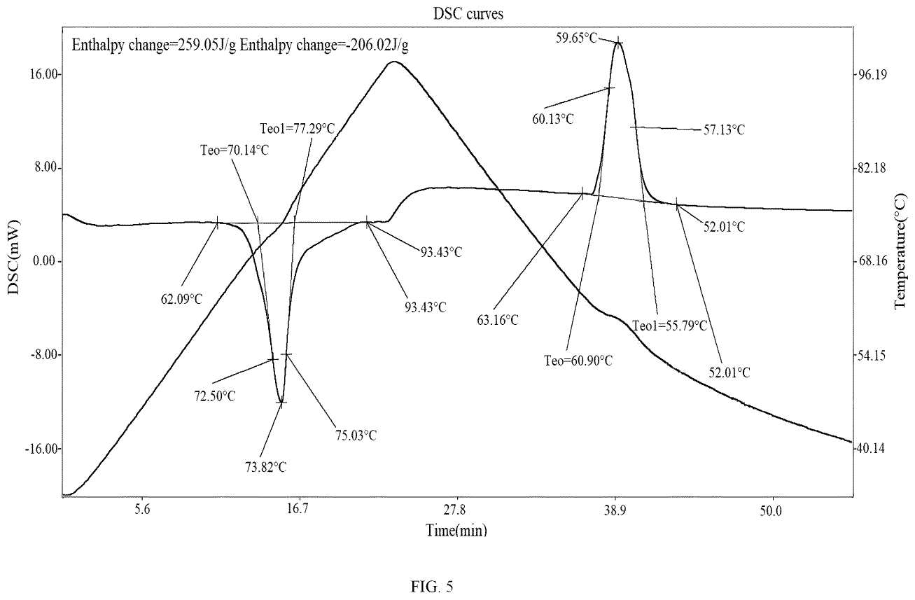

As shown in FIG. 1 to FIG. 5, the thermophysical property data of Embodiments 1-5 and the thermophysical property data of Embodiments 1-5 after 50 cycles are shown in Table 1 and Table 2, respectively.

TABLE 1
Thermophysical property data of Embodiments 1-5

| | | | | | | Thermal |
|---|---|---|---|---|---|---|
| | | | | | | storage |
| | Latent | Latent heat | | Melting | | density |
| | heat of | of | Melting | peak | Degree of | per unit |
| Experiment | fusion | solidification | temperature | temperature | subcooling | volume |
| number | (J/g) | (J/g) | (° C.) | (° C.) | (° C.) | (J/cm³) |
| Embodiment 1 | 261.56 | 198.91 | 69.47 | 73.60 | 8.64 | 347.84 |
| Embodiment 2 | 262.40 | 212.32 | 69.44 | 74.10 | 9.34 | 348.99 |
| Embodiment 3 | 261.15 | 209.78 | 69.38 | 73.73 | 9.85 | 347.33 |
| Embodiment 4 | 260.67 | 204.43 | 69.10 | 73.40 | 9.30 | 346.69 |
| Embodiment 5 | 259.05 | 206.02 | 70.14 | 73.82 | 9.24 | 344.54 |

TABLE 2
Thermophysical property data of Embodiments 1-5 after 50 cycles

| | | | | | | Thermal |
|---|---|---|---|---|---|---|
| | | | | | | storage |
| | Latent | Latent | | Melting | Degree | density |
| | heat of | heat of | Melting | peak | of | per unit |
| Experiment | fusion | solidification | temperature | temperature | subcooling | volume |
| number | (J/g) | (J/g) | (° C.) | (° C.) | (° C.) | (J/cm³) |
| Embodiment 1 | 260.10 | 197.46 | 70.02 | 73.72 | 9.13 | 345.93 |
| Embodiment 2 | 262.58 | 210.78 | 69.49 | 73.40 | 9.44 | 349.23 |
| Embodiment 3 | 259.04 | 205.76 | 69.30 | 74.00 | 9.30 | 344.35 |
| Embodiment 4 | 259.33 | 204.05 | 69.64 | 73.51 | 9.38 | 344.91 |
| Embodiment 5 | 260.27 | 208.01 | 70.26 | 74.44 | 9.46 | 346.16 |

From the two tables above, it may be seen that after 50 cycles, there is not much change in the degree of supercooling and latent heat of phase change from Embodiment 1 to Embodiment 5; from the perspective of thermal storage density per unit volume, whether before or after cycling, the phase change material added with 0.1% alkylolamide phosphate has the highest latent heat of phase change and a better thermal storage density per unit volume. Therefore, the sample obtained from Embodiment 2 is the best.

Corrosivity test: as shown in FIG. 6, the samples from Embodiment 2 and Comparative example 1 are prepared 0.5 mol/L aqueous solutions, respectively, and the electrochemical tafel curves of the solutions are tested by using an electrochemical workstation. As shown in Table 3, the self-corrosion potential of Embodiment 2 is higher than that of Comparative example 1, the self-corrosion current of Embodiment 2 is lower than that of Comparative example 1, and the polarization resistance of Embodiment 2 is higher than that of Comparative example 1. The above results indicate that the corrosiveness of Embodiment 2 is smaller than that of Comparative example 1.

TABLE 3
Test results of tafel curves of Embodiment
2 and Comparative example 1

| | Self-corrosion | Self-corrosion | Polarization |
|---|---|---|---|
| Sample | potential (E_{c}/V) | current (Ic/μA) | resistance (R/Ω) |
| Embodiment 2 | −0.484 | 0.5889 | 71808 |
| Comparative | −0.657 | 0.8494 | 52250 |
| example 1 | | | |

Autonomous combustion test: a certain amount of the sample of Embodiment 2 is taken and wrapped in paper, and the outer layer of paper is ignited with a lighter, and after the outer layer of paper has burned, it was observed whether the sample inside may burn autonomously. The results show that the sample of Embodiment 2 does not show autonomous combustion behavior, which indicates that the sample has good flame retardancy.

The DSC-500B differential scanning calorimetry produced by Shanghai Innuo Precision Instruments Co., Ltd. is used to measure the temperature and latent heat of phase change of the prepared samples. The specific process is as follows: 10 mg sample is placed into an aluminum crucible with a lid, and nitrogen is used as the purge gas and protective gas at a flow rate of 20 mL/min; the temperature range for test is from room temperature to 100° C.; under the nitrogen atmosphere, the temperature is increased from room temperature to 100° C. at a rate of 3° C./min, and decreased from 100° C. to room temperature at a rate of −3° C./min.

The tafel curves of Embodiment 2 and Comparison example 1 are measured by using a CH1760E electrochemical workstation produced by CH Instruments, Inc. Xi'an branch. through the four-electrode method with a calomel electrode as the reference electrode at room temperature and a scanning rate of 0.01 V/s.

The above embodiments are some embodiments of the present disclosure, in addition to which the present disclosure may be realized in other ways, and any obvious substitutions without departing from the present disclosure are within the scope of protection of the present disclosure.

What is claimed is:

1. A composite phase change material with a high thermal storage density, comprising oxalic acid dihydrate, organic acid, magnesium sulfate heptahydrate and alkylolamide phosphate ester, wherein the composite phase change material is prepared according to following proportions, steps, and reaction conditions:
S1: under stirring conditions, mixing oxalic acid dihydrate, organic acid, magnesium sulfate heptahydrate and alkylolamide phosphate ester uniformly in parts by mass to obtain a mixture A;
S2: sealing and keeping the mixture A obtained in the S1 at a certain temperature for a certain time and then magnetically stirring the mixture A at a constant temperature for a certain time to obtain a mixture B; and
S3: naturally cooling the mixture B obtained in the S2 to a room temperature for solidification to obtain the composite phase change material.

2. The composite phase change material with a high thermal storage density according to claim 1, wherein in the S1, the oxalic acid dihydrate, the organic acid, the magnesium sulfate heptahydrate and the alkylolamide phosphate ester are in a ratio of 40:60:1:0.05-0.4 in parts by mass.

3. The composite phase change material with a high thermal storage density according to claim 1, wherein in the S1, the oxalic acid dihydrate, the organic acid, the magnesium sulfate heptahydrate and the alkylolamide phosphate ester are in a ratio of 40:60:1:0.1 in parts by mass.

4. The composite phase change material with a high thermal storage density according to claim 1, wherein in the S1, the organic acid is glutaric acid.

5. The composite phase change material with a high thermal storage density according to claim 1, wherein in the S2, the sealing is carried out at 95-105° C. for 2.5-3.5 h, and the magnetic stirring is carried out at 100° C. for 20-30 min.

6. The composite phase change material with a high thermal storage density according to claim 1, wherein in the S2, the sealing is carried out at 100° C.

7. The composite phase change material with a high thermal storage density according to claim 1, wherein in the S2, the sealing is carried out at 100° C. for 3 h.

8. The composite phase change material with a high thermal storage density according to claim 1, wherein in the S2, the magnetic stirring is carried out for 25 min.
